(19) United States
(12) Patent Application Publication
(10) Pub. No.: US 2025/0283409 A1
(43) Pub. Date: Sep. 11, 2025

(54) DIRECTIONAL INDICATOR DEVICE

(71) Applicant: Frederick Willem Coenraad SMITH, DELMAS (ZA)

(72) Inventor: Frederick Willem Coenraad SMITH, DELMAS (ZA)

(21) Appl. No.: 18/909,965

(22) Filed: Oct. 9, 2024

(30) Foreign Application Priority Data
Mar. 5, 2024 (ZA) 2024/01847

(51) Int. Cl. E21F 17/18; G08B 5/36

(52) U.S. Cl. CPC E21F 17/18; G08B 5/36

(57) ABSTRACT

This invention relates to a directional indicator device 10 for use with an underground rope guidance system. The device 10 visually and tactilely guides underground workers to safety by way of directional flashing and a conically shaped body. To this end, the device 10 has a body 12 which is configured to be mounted to a rope 14 of the rope guidance system via a medial passageway 21. The invention is characterized in that the body 12 has a broad end and defines an inner cavity 17 for receiving a battery 16 and a pair of LEDs 15A, 15B therein. The body 12 further comprises a C-shaped lid 20 which is configured to be received over the open broad end to close it. Finally, the body 12 comprises a wedge 22 which is used to secure the body 12 to the rope 14.

### FIELD OF INVENTION

This invention relates to underground mining rescue equipment. More specifically, it relates to a cone-shaped guidance device, referred to as a safe zone cone, for use with an underground rope guidance system, also known as a “lifeline” or “beeline”.

### BACKGROUND OF INVENTION

Mining involves highly hazardous activities, e.g. blasting. The risk factors are exacerbated in underground mines. In an underground mining environment, it is a statutory requirement to have a refuge bay. The purpose of a refuge bay is to provide a safe place for miners to go to in an emergency, such as when there is an underground explosion or fire. Underground explosions can lead to fires, and the release of toxic smoke and carbon monoxide. In these conditions, power outages, causing darkness and lack of ventilation leaves the miner with limited time to get to the safety of a refuge bay. Chemical Oxygen Self Rescuers will only last between 30 to 60 minutes, depending on the product. Refuge bays are equipped with, food, water, and medical supplies, and are provided with fresh air supply. Accordingly, fresh air is pumped into the refuge bay through a hole that opens to the surface. The refuge bay is kept under positive pressure with fresh air so that toxic smoke and carbon monoxide from an underground fire cannot enter the refuge bay. Miners can safely stay in a refuge bay for days until they are rescued.

The existing rope guidance system or lifeline comprises a rope with a plurality of conical members longitudinally attached to the rope at regularly spaced apart positions along a length of the rope. The rope is secured to a roof or sidewall of an underground tunnel and, in the case of an emergency, guides a miner to the safety of a refuge bay, or to a mine exit, by providing a visual and tactile indication of a direction to follow to reach safety. The conical members serve as directional indicators. They are typically brightly coloured and due to their conical shape, provide a tactile indication of correct direction of travel to miners walking the lifeline in total darkness, smoke or dust haze. The lifeline, therefore, provides the worker with a tangible indication of the direction to a refuge bay. To make use of the rope guidance system, the miner grabs hold of the rope and slides their hand across the rope whilst walking alongside the rope. If their hand contacts a narrow end of the conical member first, such that their hand slides over the body of the conical member and exits over a wide end, then it indicates to the miner that they are going in the right direction towards safety. However, if contact is made with the wide end of the conical member first, the miner knows that they are going in the wrong direction and they need to turn around.

Typically, all lifelines consist of a rope with cones on it. A distance between cones can vary depending on statutory requirements. Cones can be fixed to the rope during the manufacturing process, or some cones can be supplied as loose items that are clipped over the rope after the rope has been installed and tensioned. Some of these cones are equipped with reflective material to make them more visible in the dark. Typically, the wide side of the cone is positioned in the direction of the refuge bay.

Although the existing lifeline seems to work, the Applicant believes that there is a need for improvement. The present invention aims to provide a rope guidance system with improved visibility.

### SUMMARY OF INVENTION

In accordance with a first aspect of the invention, there is provided a directional indicator device for use with an underground rope guidance system in an underground mine, the directional indicator device including:
a body which is configured to be attached to a rope of the underground rope guidance system; and
at least one light source which is connected to or housed within the body.

The body may have a conical shape. Furthermore, the body may define an inner cavity for housing the light source. The body may be at least partially transparent. The body may be green in colour. The directional indicator device may further include a power source which is configured to power the light source. The power source may be a C-shaped battery which is housed inside the inner cavity of the body.

The light source may take the form of a Light Emitting Diode (LED). The directional indicator device may include at least two light sources which are longitudinally spaced apart relative to the body. The two light sources may take the form of a pair of LEDs. The LEDs of the directional indicator device may be configured to flash recurringly at regular intervals. The directional indicator device may be configured for directional flashing. More specifically, the light sources may be configured to flash in a manner which indicates a correct direction of travel to an exit or refuge bay.

The LEDs may be configured to flash recurringly at regular intervals in a manner which gives rise to directional flashing such that the light sources are configured to indicate a correct direction of travel to an exit or refuge bay.

The conical body may have a tapered or narrow end and an opposing broad end. The body may comprise a conical segment and a circular cylindrical segment. The body may define a longitudinally extending medial axis.

The body of the directional indicator device may define a medial, longitudinally extending passageway for accommodating the rope of the underground rope guidance system.

To this end, the body may include a housing defining the inner cavity for accommodating the light source and a power source and a lid for closing the inner cavity. The lid may include a seal or gasket for preventing ingress of water into the inner cavity. The directional indicator device may be intrinsically safe. The body may further include a wedge which is configured to be received in a longitudinally extending complemental slot defined in the housing. The wedge when slid into the slot secures the directional indicator device to the rope. The body may further include a wedge which is configured to be received in a longitudinally extending complemental slot defined in the housing such that when the wedge is slid into the slot, it secures the directional indicator device to the rope.

The wedge may include a primary part and a pair of laterally projecting wedge-shaped keys which flank the primary part. The wedge-shaped keys are configured to be received in complementary keyways or grooves formed in the housing of the body such that when the wedge is inserted into the slot, the keyways urge the wedge into abutment with a rope received in the medial passageway thereby securing the directional indicator device to the rope.

A radially inwardly disposed surface of the wedge may define gripping formations for gripping onto the rope.

The housing and lid of the body may have a C-shaped cross-sectional profile. Furthermore, the power source may be C-shaped.

The housing may have internal ridges which are configured to reflect light outwardly. Also, the body may have internal ridges which are configured to reflect light outwardly.

In accordance with another aspect of the invention, there is provided an underground rope guidance system which includes:
a rope or cable; and
a plurality of directional indicator devices as described above connected to the rope at spaced apart positions along a length of the rope.

### BRIEF DESCRIPTION OF DRAWINGS

The invention will now be further described, by way of example, with reference to the accompanying diagrammatic drawings.

In the drawings:

FIG. 1 shows a three-dimensional assembled view of a directional indicator device in accordance with the invention;

FIG. 2 shows a side elevation of the directional indicator device of FIG. 1;

FIG. 3 shows a three-dimensional exploded view of the directional indicator device;

FIG. 4 shows another three-dimensional exploded view of the directional indicator device from a different angle; and

FIG. 5 shows a side elevation of the exploded view of FIG. 4.

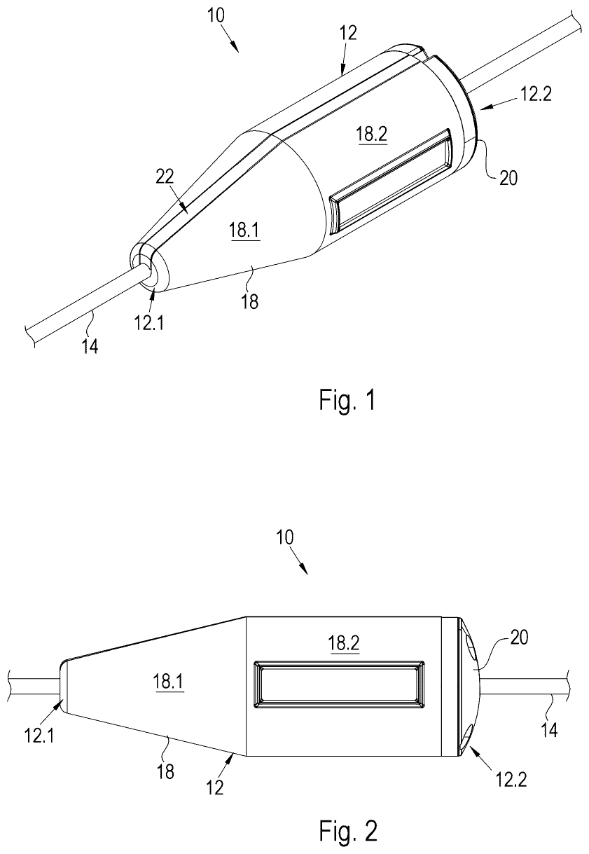

### DETAILED DESCRIPTION OF THE EMBODIMENT

The following description of the invention is provided as an enabling teaching of the invention. Those skilled in the relevant art will recognise that many changes can be made to the embodiments described, while still attaining the beneficial results of the present invention. It will also be apparent that some of the desired benefits of the present invention can be attained by selecting some of the features of the present invention without utilising other features. Accordingly, those skilled in the art will recognise that modifications and adaptations to the present invention are possible and can even be desirable in certain circumstances and are a part of the present invention. Thus, the following description is provided as illustrative of the principles of the present invention and not a limitation thereof.

In the Figures, reference numeral 10 refers generally to a directional indicator device for use with an underground rope guidance system, known as a “Lifeline”, in an underground mine. The directional indicator device 10 may also be referred to as a Safe Zone Cone. The directional indicator device 10 has a part-conical, robust body 12 which is configured to be mounted to a rope 14 of the rope guidance system, as can be seen in the Figures.

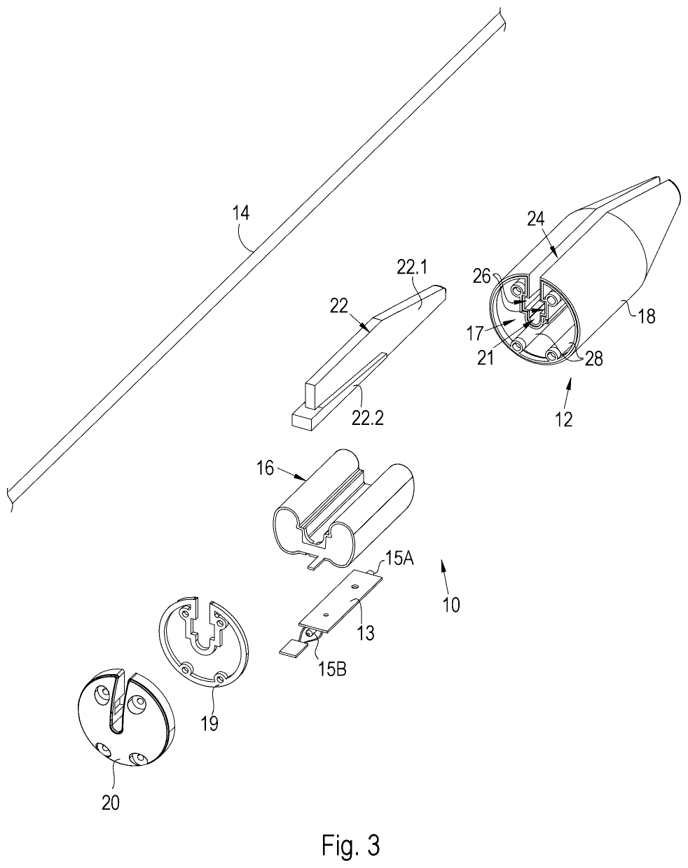

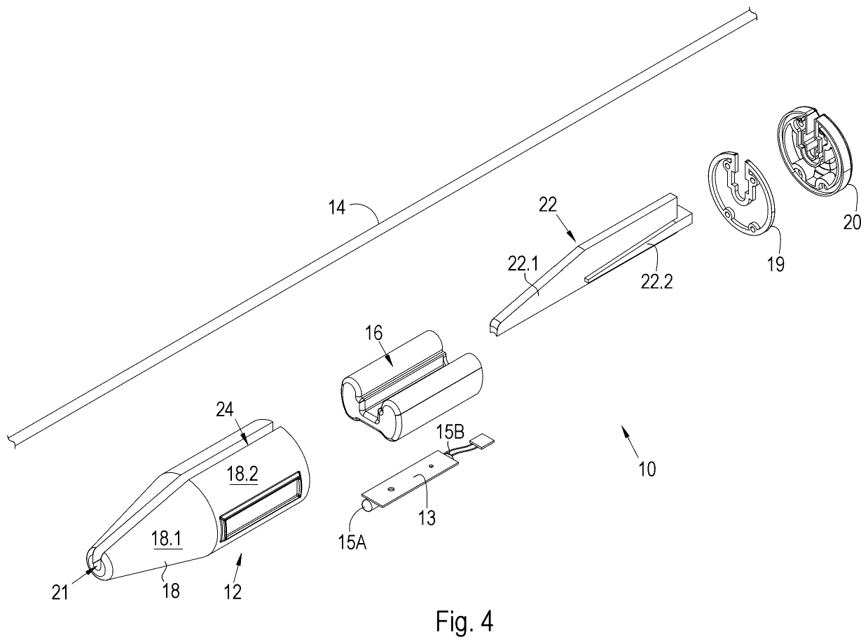

The conical body 12 has a tapered or narrow end 12.1 and an opposing broad end 12.2. As is well known in the mining industry, the conical shape of the body 12 serves to indicate to a miner a correct direction to follow to reach a refuge bay or safe zone, in the event of an emergency. The invention is characterized in that the part-conical body 12 comprises a housing 18 which has an open broad end and defines a generally C-shaped inner cavity 17 (see FIG. 3) for receiving a C-shaped battery 16 and at least one light source. More specifically, the light source takes the form of a pair of Light Emitting Diodes (LEDs) 15A, 15B housed within the inner cavity 17. The body 12 further comprises a C-shaped lid or cover 20 which is configured to be received over the open broad end of the housing 18 to close it. Finally, the body 12 comprises a wedge 22 which is used to secure the body 12 to the rope 14. The housing 18 comprises a conical segment 18.1 toward the narrow end 12.1 and a circular cylindrical segment 18.2 toward the broad end 12.2. The body 12 defines a longitudinally extending medial axis. In order to secure the body 12 to the rope 14, the body 12 of the directional indicator device 10 has a medial, longitudinally extending passageway 21 (see FIGS. 3 and 4) for accommodating the rope 14 of the underground rope guidance system.

The lid 20 has a seal or gasket 19 for preventing ingress of water into the inner cavity 17. In order to secure the body 12 to the rope 14, with the rope seated in the passageway 21, the wedge 22 is inserted into a longitudinally and laterally extending complemental rope slot 24 defined by the housing 18. The wedge 22, when slid into the slot 24, prevents withdrawal of the rope 14 from the passageway 21 thereby securing the directional indicator device 10 to the rope 14. The lid 20 closes over and end of the wedge 22 and is secured in place using four stainless steel screws (not shown). This prevents the wedge 22 from being withdrawn from the slot 24.

To improve visibility of the directional indicator device 10 underground, the LEDs 15A, 15B are driven by the battery 16 and LED circuitry to flash recurringly at regular intervals and in short succession of one another. Accordingly, the directional indicator device 10 is configured for directional flashing. More specifically, the LEDs flash in a manner which indicates a correct direction of travel to an exit or refuge bay. Therefore, the flashing in short succession serves to indicate to the miner the correct direction to travel to reach a place of safety. Accordingly, LED 15A positioned proximate the narrow end 12.1 of the body 12 flashes first, followed shortly thereafter by LED 15B which is positioned proximate the broad end 12.2 thus serving to indicate the direction of travel by way of the flashing sequence.

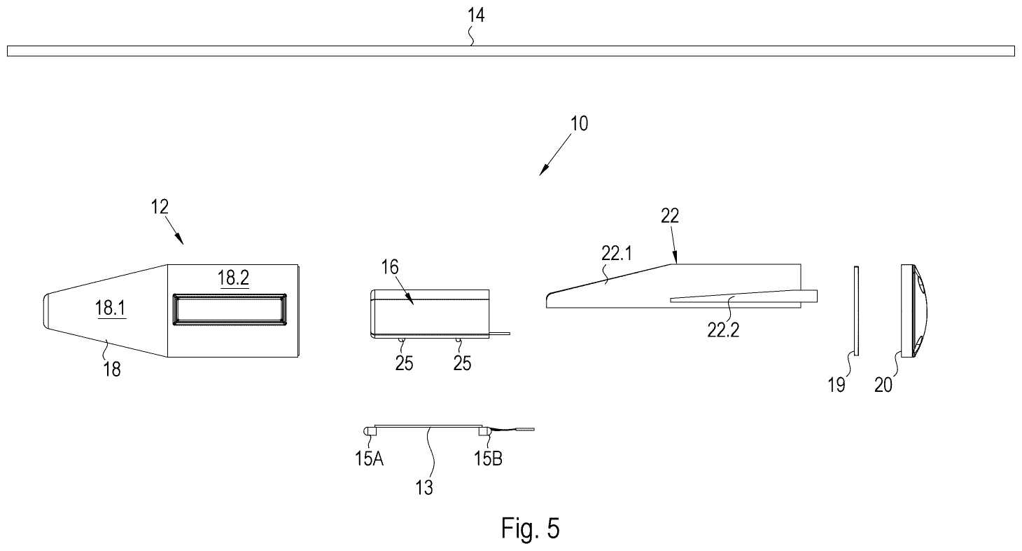

The body 12 is transparent in order to permit light radiation caused by the flashing of the LEDs to pass through, thereby to increase visibility of the directional indicator device 10 underground. The body 12 is made from a polycarbonate material and is preferably green in colour which is ostensibly the most visible colour in a dark underground environment, potentially filled with smoke. The LEDs 15A, 15B are mounted to a Printed Circuit Board (PCB) 13 which is configured to be received over a pair of longitudinally spaced apart locating formations or lugs 25 (see FIG. 5), which protrude from a side of the C-shaped battery 16. The lugs 25 protrude through complementary holes formed in the PCB 13 thereby locating the PCB 13 on the battery 16.

The wedge 22 includes a primary part 22.1 and laterally projecting wedge-shaped keys 22.2 which flank the primary part 22.1. The wedge-shaped keys 22.2 are configured to be received in complementary keyways or grooves 26 (see FIG. 3) formed in the housing 18 of the body 12 such that when the wedge 22 is slid from the broad end into the slot 24, the keyways 26 urge the keys 22.2 and hence the wedge 22 into abutment with the rope 14 received in the medial passageway 21 thereby securing the directional indicator device 10 to the rope 14. To prevent relative longitudinal displacement or slipping on the rope 14, a radially inwardly disposed surface of the wedge 22 which operatively contacts the rope 14 has gripping formations (not shown) for gripping onto the rope 14. The housing 18 has internal ridges 28 (see FIG. 3) which are configured to reflect light outwardly.

The directional indicator device 10 has been designed to be intrinsically safe for underground mining purposes.

To assemble the directional indicator device 10, the PCB 13 is placed on the lugs 25 of the battery 16. To energise the LEDs, a male connector of the PCB 13 is plugged into a female connector of the battery 16. The battery 16 and the PCB 13 are then slid into the C-shaped inner cavity 17 of the housing 18. To mount the indicator 10 to the rope 14, the housing 18 is made to slide over the rope 14 through the rope slot 24 in the housing 18. The wedge 22 is then slid into the rope slot 24 from the broad end and clamps down on the rope 14. The lid 20 is then slid over the rope and put into position over and end of the wedge 22 and made to seat firmly over the gasket 19. The lid 20 is then fixed to the housing with the four stainless steel screws.

The directional indicator device 10 is an improvement upon the existing cones used underground because it has improved visibility, especially in the dark, when compared to conventional brightly coloured cones or cones with reflective material. This is achieved due to the inclusion of the flashing LEDs. Therefore, even if a miner's headlamp has failed, they will still be able to see the directional indicator device and the correct direction to the refuge bay due to the sequential flashing of the LEDs. Furthermore, it visually and tangibly indicates direction to the refuge bay. Moreover, the directional indicator device 10 in accordance with the invention can be clamped onto the rope 14 after the rope has been tensioned making installation easy. The battery 16 is expected to last 4 years after activation. The circuitry is enclosed inside the housing 18 which is extremely robust and transparent. As mentioned, gripping formations or teeth on the wedge 22 prevent sliding or slipping after it is mounted onto the rope. Special ridges 28 inside the housing 18 help to reflect the light laterally to the sidewalk.

The directional indicator device 10 is easy to install. The body 12 is waterproof due to the seal or gasket 19 which ensures that the electronics stay safe and dry. The LEDs 15A, 15B, one in each end, flash sequentially in the direction of safety. The device 10 is removable and the battery is replaceable. Stainless steel screws are corrosion free and are screwed into brass inserts.

In the event of an explosion, it is possible that a miner's cap lamp can fail due to damage from the blast in which case reflectors are not visible. The LEDs will remain visible in this scenario. As each device 10 operates from its own individual battery 16 and is not fed through a wired system, when a wired system fails, everything downstream is dead whilst if one Safe Zone Cone fails, all the rest are still going. The battery is made in a C shape so that it can be fitted around the rope 14. Inflammable gas can result in a catastrophic underground explosion. Therefore, the Safe Zone Cone has been certified intrinsically safe to work in hazardous areas, right up to the coalface.

The Applicant believes that the visual indication of the correct direction to follow brought about by the sequential flashing of the LEDs is an incredibly significant difference when this invention is compared to the prior art. The Applicant believes that the directional indicator device 10 in accordance with the invention will enhance safety and visibility in the mining environment.

1. A directional indicator device for use with an underground rope guidance system in an underground mine, the directional indicator device including:
a body which is configured to be attached to a rope of the underground rope guidance system; and
at least one light source which is connected to or housed within the body.

2. The directional indicator device as claimed in claim 1, wherein the body has a conical shape.

3. The directional indicator device as claimed in claim 2, wherein the body defines an inner cavity for housing the light source.

4. The directional indicator device as claimed in claim 1, wherein the body is at least partially transparent.

5. The directional indicator device as claimed in claim 1, which includes a power source which is configured to power the light source, wherein the power source is a C-shaped battery which is housed inside an inner cavity of the body.

6. The directional indicator device as claimed in claim 1, which includes at least two light sources which are longitudinally spaced apart relative to the body, wherein the two light sources take the form of a pair of LEDs which are configured to flash recurringly at regular intervals in a manner which gives rise to directional flashing such that the light sources are configured to indicate a correct direction of travel to an exit or refuge bay.

7. The directional indicator device as claimed in claim 2, wherein the conical body has a tapered or narrow end and an opposing broad end, the body comprising a conical segment and a circular cylindrical segment, the body defining a longitudinally extending medial axis, wherein the body also defines a medial, longitudinally extending passageway for accommodating the rope of the underground rope guidance system.

8. The directional indicator device as claimed in claim 7, wherein the body includes a housing defining an inner cavity for accommodating the light source and a power source and a lid for closing the inner cavity, the lid including a seal or gasket for preventing ingress of water into the inner cavity.

9. The directional indicator device as claimed in claim 8, wherein the body further includes a wedge which is configured to be received in a longitudinally extending complemental slot defined in the housing such that when the wedge is slid into the slot, it secures the directional indicator device to the rope.

10. The directional indicator device as claimed in claim 9, wherein the wedge includes a primary part and a pair of laterally projecting wedge-shaped keys which flank the primary part, wherein the wedge-shaped keys are configured to be received in complementary keyways or grooves formed in the housing of the body such that when the wedge is inserted into the slot, the keyways urge the wedge into abutment with the rope received in the medial passageway thereby securing the directional indicator device to the rope.

11. The directional indicator device as claimed in claim 10, wherein a radially inwardly disposed surface of the wedge defines gripping formations for gripping onto the rope.

12. The directional indicator device as claimed in claim 11, wherein the housing and lid of the body have a C-shaped cross-sectional profile.

13. The directional indicator device as claimed in claim 1, wherein the body has internal ridges which are configured to reflect light outwardly.

14. The directional indicator device as claimed in claim 1, which is retrofittable to the rope.

15. An underground rope guidance system which includes:
a rope or cable; and
a plurality of directional indicator devices as claimed in claim 1 connected to the rope at spaced apart positions along a length of the rope.
